(19) United States
(12) Patent Application Publication
(10) Pub. No.: US 2015/0277410 A1
(43) Pub. Date: Oct. 1, 2015

(54) POWER DELIVERY SYSTEM MANAGEMENT

(71) Applicants: Sandeep Gupta, Phoenix, AZ (US); Ayan Banerjee, Tempe, AZ (US)

(72) Inventors: Sandeep Gupta, Phoenix, AZ (US); Ayan Banerjee, Tempe, AZ (US)

(73) Assignee: Arizona Board of Regents on behalf of Arizona State University, Scottsdale, AZ (US)

(21) Appl. No.: 14/667,771

(22) Filed: Mar. 25, 2015

Related U.S. Application Data
(60) Provisional application No. 61/969,976, filed on Mar. 25, 2014.

(51) Int. Cl. G05B 19/042

(52) U.S. Cl. CPC G05B 19/042; G05B 2219/2639

(57) ABSTRACT

An energy management system includes a number of power sources, a first set of energy storage devices (ESDs), a second set of ESDs, and a control system. The first set of ESDs is coupled between the power sources and a load and has a first set of operating characteristics. The second set of ESDs is also coupled between the power sources and the load and has a second set of operating characteristics that are different from the first set of operating characteristics. The control system is configured to selectively deliver power from one of the plurality of power sources to the first plurality of ESDs, the second plurality of ESDs, or both and selectively deliver power from the first plurality of ESDs, the second plurality of ESDs, or both to the load based on short and long term variations in a set of energy delivery system characteristics.

### RELATED APPLICATIONS

This application claims the benefit of provisional patent application Ser. No. 61/969,976, filed Mar. 25, 2014, the disclosure of which is hereby incorporated herein by reference in its entirety.

### GOVERNMENT SUPPORT

This invention was made with government funds under contract numbers 0834797, 0855277, and 1218505 awarded by the National Science Foundation. The U.S. Government has certain rights in this invention.

### FIELD OF THE DISCLOSURE

The present disclosure relates to the management of energy storage devices (ESDs) and power supplies in order to provide low cost electricity to an infrastructure with high variability in power requirements.

### BACKGROUND

Usage of renewable energy is increasingly becoming a high priority for internet data centers (IDCs) and other large-scale computing operations to ensure long-term environmental responsibility and economical operation. In recent years, many IDCs have switched to the partial or complete use of renewable energy sources, such as solar and wind energy. Due to the variable power output of many renewable energy sources, energy buffering has been used as a way to increase the efficiency of IDC operations that are powered as such. Energy buffering utilizes energy storage devices (ESDs) such as batteries and ultra-capacitors to store energy surpluses, dispersing the stored energy when it is required. While many IDCs do include ESDs in one form or another, the ESDs have conventionally been used only as backup power sources, rather than for energy buffering. However, these ESDs have started to be used to store excess renewable energy and low-cost electricity during workload valleys, which can later be used to meet high power demands. Although energy buffering is an effective way to improve the efficiency of energy usage in IDCs and other large-scale computing operations, conventional energy management schemes fail to take full advantage of the energy buffering process. Specifically, conventional energy management schemes have thus far only taken into account long-term variations (e.g., over several hours or days) in one or more energy delivery system characteristics such as electricity price, renewable power output, and power demand of a load to determine how and when to store power to and/or disperse power from ESDs. These conventional approaches, referred to herein as “single-tier” approaches, underutilize renewable energy sources and low-cost electricity resulting in sub-optimal resource allocation. Accordingly, there is a need for an improved energy management system and/or energy management scheme to improve the efficiency of energy management in IDCs and other large-scale computing operations.

### SUMMARY

The present disclosure relates to the management of energy storage devices (ESDs) and various power sources in order to provide low cost electricity to an infrastructure with high variability in power requirements. In one embodiment, an energy management system includes a number of power sources, a first set of ESDs, a second set of ESDs, and a control system. The first set of ESDs are coupled between the power sources and a load and have a first set of operating characteristics including a first energy storage efficiency, a first discharge rate, and a first energy storage capacity. The second set of ESDs are also coupled between the power sources and the load and have a second set of operating characteristics that are different from the first set of operating characteristics and include a second energy storage efficiency, a second discharge rate, and a second energy storage capacity. The control system is configured to selectively deliver power from one of the plurality of power sources to the first plurality of ESDs, the second plurality of ESDs, or both and selectively deliver power from the first plurality of ESDs, the second plurality of ESDs, or both to the load based on short term and long term variations of a set of energy delivery system characteristics which include a variability of power demand to the load and the price of electricity from each one of the plurality of power sources. Because the control system takes into account both the short term variability and the long term variability of the energy delivery system characteristics, the energy management system may more effectively utilize power from the power sources in order to minimize the cost of power delivered to the load.

In one embodiment, the energy delivery system characteristics further include the first set of operating characteristics and the second set of operating characteristics.

In one embodiment, the control system may be further configured to selectively deliver power between the first set of ESDs and the second set of ESDs based on the energy delivery system characteristics.

The power sources may include a renewable energy source and a power grid. The first set of ESDs may be batteries while the second set of ESDs may be ultra-capacitors. The short term variability of the energy delivery system characteristics may be the variation in one or more of the energy delivery system characteristics over a period of minutes, while the long term variability of the energy delivery system characteristics may be the variation in one or more of the energy delivery system characteristics over a period of hours.

In one embodiment, a method of operating a control system for an energy management system includes delivering power from a number of power sources to a first set of ESDs, a second set of ESDs, or both and delivering power from the first set of ESDs, the second set of ESDs, or both to a load depending on short term and long term variations of a set of energy delivery system characteristics. The energy delivery system characteristics include a variability of power demand to a load and a price of electricity from each one of the power sources. The first set of ESDs have a first set of operating characteristics including a first energy storage efficiency, a first discharge rate, and a first energy storage capacity. The second set of ESDs have a second set of operating characteristics that are different from the first set of operating characteristics and include a second energy storage efficiency, a second discharge rate, and a second energy storage capacity. Because the control system takes into account both the short term variability and the long term variability of the energy delivery system characteristics, the method may more effectively utilize power form the power sources in order to minimize the cost of power delivered to the load.

Those skilled in the art will appreciate the scope of the disclosure and realize additional aspects thereof after reading the following detailed description in association with the accompanying drawings.

### BRIEF DESCRIPTION OF THE FIGURES

FIGS. 1A and 1B show an energy management system according to one embodiment of the present disclosure.

FIG. 2 is a flow chart illustrating a method of controlling an energy management system according to one embodiment of the present disclosure.

FIGS. 3A through 3C show graphs illustrating the advantages of a multi-tier energy management scheme according to one embodiment of the present disclosure.

FIGS. 4A and 4B are graphs illustrating variability in a workload according to one embodiment of the present disclosure.

FIGS. 5A and 5B are graphs illustrating variability in renewable energy source output according to one embodiment of the present disclosure.

FIGS. 6A and 6B are graphs illustrating variability in renewable energy source output according to one embodiment of the present disclosure.

FIGS. 7A through 7F are graphs illustrating cost savings due to a multi-tier energy management scheme according to various embodiments of the present disclosure.

FIG. 8 is a graph illustrating an increase in utilization of renewable energy sources due to a multi-tier energy management scheme according to one embodiment of the present disclosure.

FIGS. 9A and 9B are graphs illustrating an increase in utilization of renewable energy source due to a multi-tier energy management scheme according to one embodiment of the present disclosure.

### DETAILED DESCRIPTION

The embodiments set forth below represent the necessary information to enable those skilled in the art to practice the disclosure and illustrate the best mode of practicing the disclosure. Upon reading the following description in light of the accompanying drawings, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Energy buffering, the process of storing energy surpluses in one or more energy storage devices (ESDs) for later use on demand, has been used to store renewable energy and low cost energy and use it judiciously to reduce electricity bills in internet data centers (IDCs) and other operations in which power consumption variability is high. As discussed above, conventional single-tier energy management schemes have considered long-term variations in one or more energy delivery system characteristics such as electricity price, renewable power output, and power demand of a load and have shown a reduction in the electricity costs of operations using such energy buffering techniques. However, in addition to long-term variations in these energy delivery system characteristics, short-term variations also exist, which can be further leveraged to decrease electricity costs as discussed in detail below. Further, inherent heterogeneity in the physical characteristics (e.g., charging and discharging rates) of ESDs can also be leveraged to decrease electricity costs. The energy management scheme described herein, which considers both long-term and short-term variations in one or more energy delivery system characteristics, is referred to as a “multi-tier” energy management scheme and is capable of leveraging long-term and short-term variations in one or more energy delivery system characteristics, as well as the heterogeneity of ESDs, in order to better optimize utilization of renewable energy and low-cost power. By framing each tier of the energy buffering management scheme as an optimization problem and solving them in an online and proactive way using Receding Horizon Control (RHC), a highly cost-efficient energy buffering management system can be created, as described in further detail below.

Generally, the inventors discovered that an energy buffering management system should be aware of the intermittent nature of available energy from renewables, variability in workload (i.e., power demand of a load), variability in the electricity pricing, and heterogeneity in ESDs in terms of energy storage efficiency, discharge rate, and storage capacity both in the short term and the long term. In light of this short and long term variability, integrated multi-tier management of renewables, ESDs, and data center workload will generally reduce electricity cost and increase renewable energy utilization.

A fundamental problem in energy management is matching variable power demand from a load with low-cost grid and intermittent green energy. Conventional solutions have focused on a single-tier approach, leveraging long-term variability of energy delivery system characteristics as discussed above. These approaches ignore the tradeoff between the cost efficiency of ESDs and close matching of power demand with low-cost grid and green energy (i.e., matching of power demand with low-cost grid and green energy in the short term). Close matching of power demand and supply needs frequent charging/discharging of ESDs. However, maximum utilization of renewables necessitates high energy density ESDs for storage of green energy. These high energy density ESDs generally impose a cap on the frequency of charging and discharging thereof. Accordingly, the inventors discovered that by using both high energy density ESDs and low energy density ESDs (i.e., by providing heterogeneous ESDs) as discussed in detail below, close power matching can be achieved while simultaneously increasing utilization of renewable energy.

Energy management is typically performed in a time-stepped system where time is discretized into intervals called epochs. For single-tier energy management schemes, the time interval is generally compatible with the charging/discharging rate of batteries (e.g., hours). The inputs to a single-tier management include the variability of one or more energy delivery system characteristics over a period of epochs. In other words, the high-resolution details of the energy delivery system characteristics are hidden from the management scheme. The management scheme assumes this information is evenly spaced within epochs. Due to this assumption, the high-resolution details that occur at a time scale less than the epochs are ignored in the decision making of the manager, resulting in non-optimal decisions on energy buffering. A multi-tier energy management scheme, which operates at long and short intervals, can explore the data in higher resolution and optimize use of renewable energy cost further. The benefit of a multi-tier compared to a single-tier energy management scheme is discussed herein, considering the variability of the available renewable energy and the power demand across epochs.

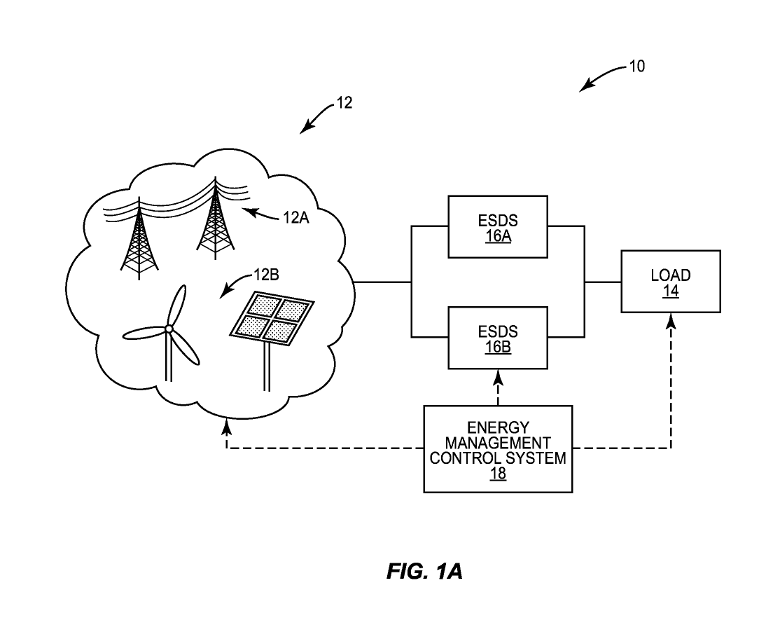

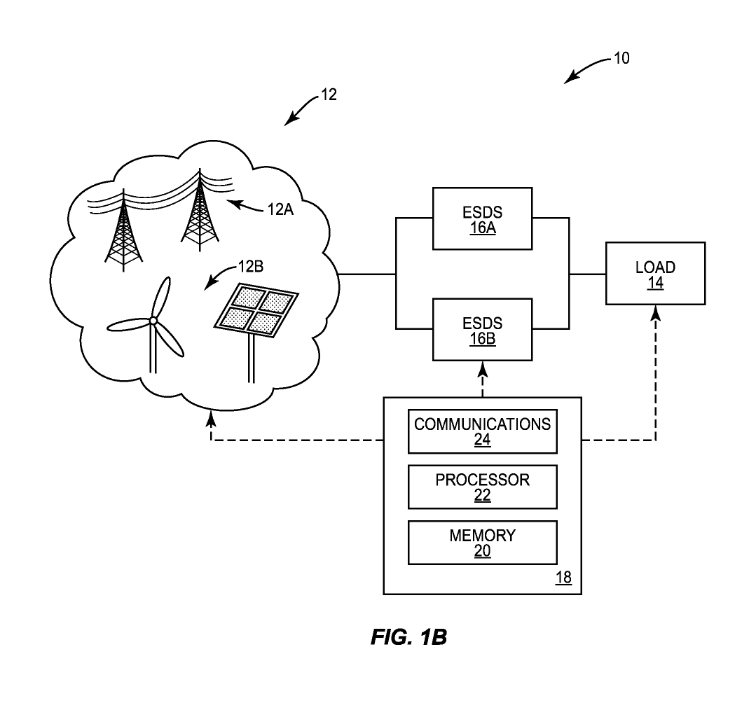

FIG. 1A shows an energy delivery system 10 according to one embodiment of the present disclosure. The energy delivery system 10 includes a number of energy sources 12, which may include an electrical grid 12A and any number of renewable energy sources 12B, a load 14, a first set of ESDs 16A and a second set of ESDs 16B coupled between the energy sources 12 and the load 14, and an energy management control system 18. As discussed in further detail below, the energy management control system 18 is configured to selectively deliver power from one or more of the energy sources 12 to the first set of ESDs 16A, the second set of ESDs 16B, or both, selectively deliver power between the first set of ESDs 16A and the second set of ESDs 16B, and selectively deliver power from the first set of ESDs 16A and the second set of ESDs 16B to the load 14 depending on short and long term variations of one or more energy delivery system characteristics. The energy delivery system characteristics may include power demand of the load, the price of electricity from each one of the energy sources 12, and the operating characteristics of the first set of ESDs 16A and the second set of ESDs 16B. The operating characteristics of the first set of ESDs 16A and the second set of ESDs 16B may include an energy storage efficiency, a discharge rate, and an energy storage capacity. Notably, the operating characteristics of the first set of ESDs 16A may be different than those of the second set of ESDs 16B in order to provide heterogeneity thereof to the energy delivery system 10.

FIG. 1B shows the energy delivery system 10 including details of the energy management control system 18 according to one embodiment of the present disclosure. The energy management control system 18 includes a memory 20, a processor 22, and communications circuitry 24. The memory 20 and the processor 22 are configured to evaluate the short and long term variations of the one or more energy delivery system characteristics discussed above. The communications circuitry 24 is configured to provide control signals as necessary in order to facilitate the selective delivery of power from one or more of the energy sources 12 to the first set of ESDs 16A, the second set of ESDs 16B, or both, the selective delivery of power between the first set of ESDs 16A and the second set of ESDs 16B, and the selective delivery of power from the first set of ESDs 16A and the second set of ESDs 16B to the load 14 depending on the short and long term variations of the one or more energy delivery system characteristics.

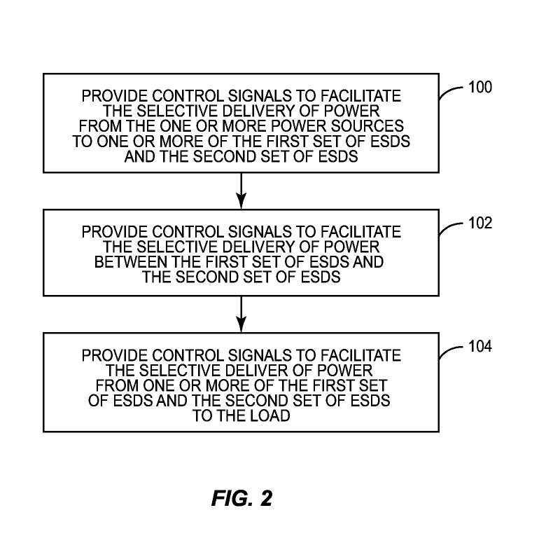

FIG. 2 shows a method of operating an energy management control system according to one embodiment of the present disclosure. First, the energy management control system 18 provides control signals to the energy delivery system 10 in order to facilitate the selective delivery of power from one or more of the energy sources 12 to one or more of the first set of ESDs 16A and the second set of ESDs 16B based on the short term and long term variation of one or more of the energy delivery system characteristics discussed above (step 100). Next, the energy management control system 18 provides control signals to the energy delivery system 10 in order to facilitate the selective delivery of power between the first set of ESDs 16A and the second set of ESDs 16B based on the short term and long term variation of one or more of the energy delivery system characteristics (step 102). Finally, the energy management control system 18 provides control signals to the energy delivery system 10 in order to facilitate the selective delivery of power from one or more of the first set of ESDs 16A and the second set of ESDs 16B to the load 14 based on the short term and long term variation of one or more of the energy delivery system characteristics (104)

In order to demonstrate the utility of the foregoing energy management system and energy management scheme in general, an internet data center (IDC) is assumed to obtain its required power from a mix of grid, solar, wind, and ESDs. An incoming workload is assumed that includes short requests (or transactions). The workload is assumed to be processed by any server in the data center. Further, it is assumed that the data center has N homogeneous servers and deploys multiple heterogeneous types of ESDs which are managed in a multi-tier management scheme as discussed above. For simplicity, two types of ESDs (high and low energy density ESDs) are assumed, in general, however, the methodology disclosed herein can be extended to more than two levels. For the purposes of the present disclosure, the first set of ESDs 16A are assumed to be high energy density ESDs, while the second set of ESDs 16B are assumed to be low energy density ESDs. ESDs can supply their charging power from both grid and renewable power, which can be used to power every server when needed (in general ESDs can be deployed at the server level, rack level, or data center level, and the analysis herein is based on data center level deployment).

Time is divided into epochs of length τ and each epoch, in turn, consists of K slots of length τ¹. For example, an epoch can correspond to a few hours in a day and a slot can correspond to minutes. T1 and T2, the tier one and the tier two workload and energy-buffering managers, are then developed, operating at epochs and slots, respectively. Leveraging long-term variation of the available renewable energy, electricity cost and power demand, T1 decides on the energy buffering management of the high energy density ESDs such as the first set of ESDs 16A discussed above, which can sustain large energy for a long duration. Similarly, leveraging short-term variation of the available renewable energy, electricity cost and power demand, T2 decides on the number of active servers as well as energy buffering management of low energy density ESDs such as the second set of ESDs 16B discussed above. The objective of the optimization is to minimize the electricity price by leveraging ESDs to efficiently utilize low cost electricity and renewable energy sources.

Before delving into the details of the disclosure, some definitions of terms are provided in Table 1 to aid in understanding the following disclosure.

TABLE 1

| Symbol | Definition |
|---|---|
| t | epoch index |
| T | T1 entire time horizon |
| W | T1 prediction window |
| k | slot index |
| K | number of slots per epoch |
| τ | epoch length (seconds) |
| τ′ | slot length (seconds) |
| p^{ESD} | charging/discharging rate |
| p^{max, discharge} | maximum discharging rate |
| p^{max, charge} | maximum charging rate |
| B^{size} | ESD capacity |
| γ | charging/discharging cost |
| η | ESD self-discharge rate |
| p^{AC} | power draw from grid |
| p^{total} | total power cons. |
| r^{total} | average green power |
| r | renewable harvesting |
| p | power of each server |
| p₀ | threshold peak power |
| b | variable for battery cost |
| α | energy cost |
| β | cost per peak power |
| y | number of active servers |
| μ | service rate |
| λ | workload arrival rate |
| d^{ref} | reference delay |

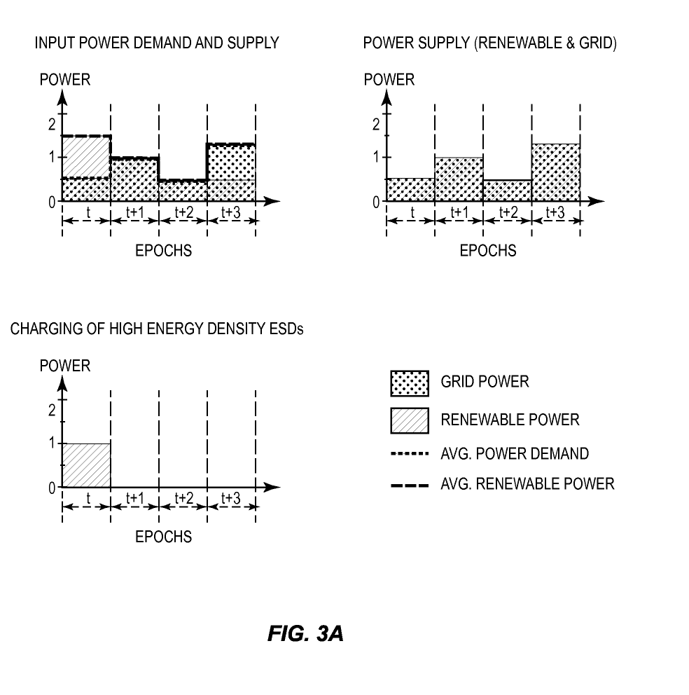

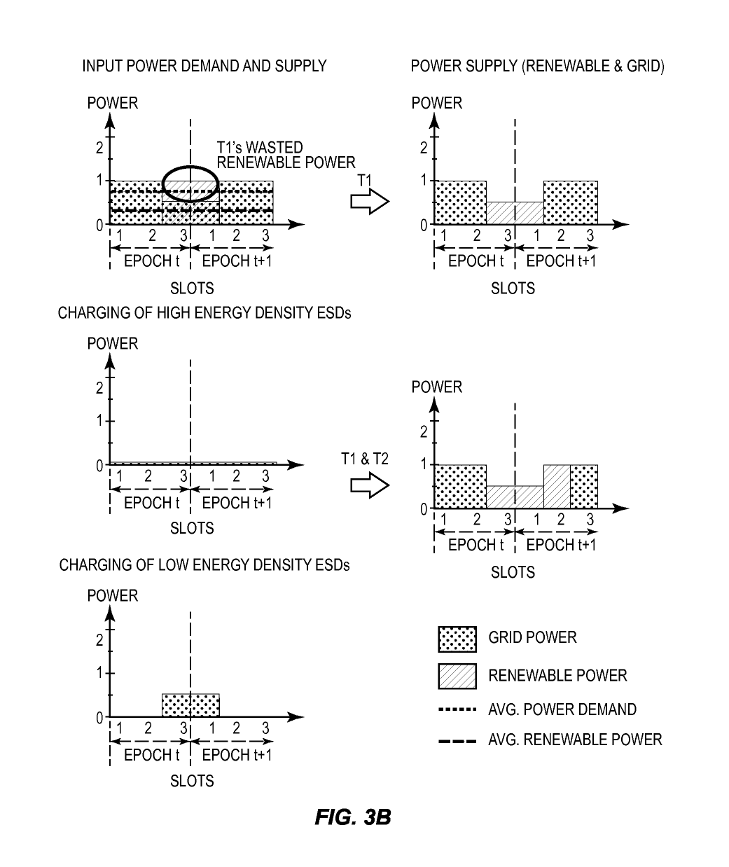

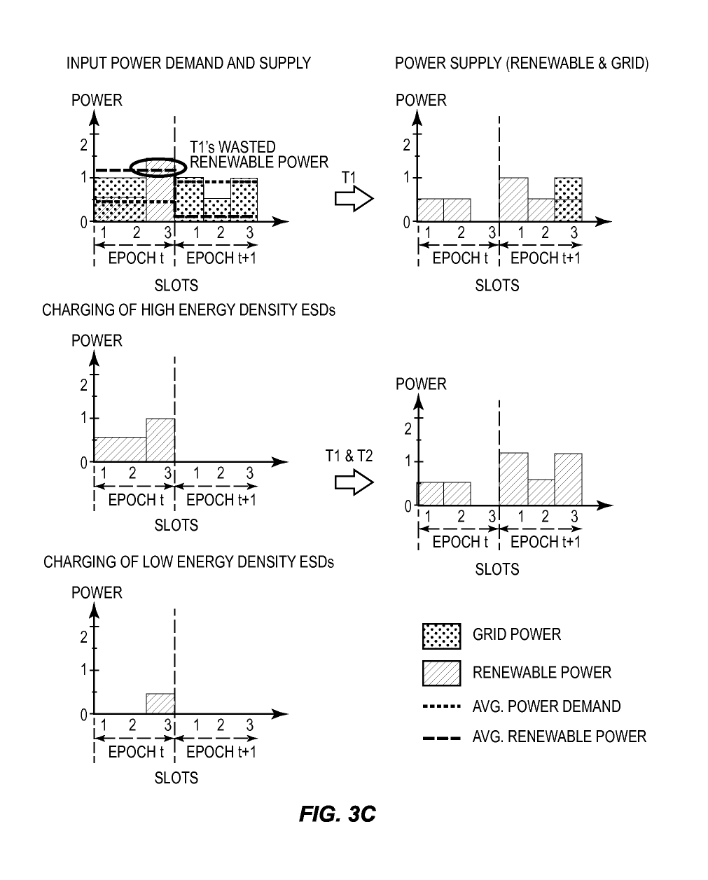

Turning now to FIG. 3, three cases where the two-tier management utilizes more renewable power than one-tier management (only T1 or only T2) are shown:
Case 1 (the need for T1): FIG. 3A shows a case wherein excess renewable energy should be stored for several epochs (a relatively long period time). Specifically, FIG. 3A shows a case where excess renewable energy is stored for three epochs. While ESDs such as ultra-capacitors cannot sustain energy for long periods of time due to their high self-discharge, batteries can sustain energy for long periods of time, which can be managed in long term due to their limited charging rate.
Case 2 (the need for T2): FIG. 3B shows a case with given slot and epoch level variation of power demand and renewable power (each epoch is assumed to have three slots). Since the average renewable power over the epoch t and t+1 is less than that of the power demand, there is no excess renewable power in average such that T1 cannot charge a battery from renewable power in these epochs. However, the available renewable power in the third slot of epoch t and in the first slot of epoch t+1 is higher than that of the power demand. T2 can utilize ultra-capacitors to store the excess renewable power observed over these slots for use in epoch t+1, second slot. In other words, the short-term variation of the power demand and green power that are neglected by T1 may be negatively correlated as depicted by the figure. This necessitates utilizing an energy storage and a short term management scheme to match between the two.
Case 3 (the need for T2): FIG. 3C shows an example where T1 charges the battery from excess renewable energy in epoch t for using in epoch t+1. However due to a limited charging rate of the battery, all of the excess renewable power available in epoch t, third slot cannot be harvested by the battery. A combined T1 and T2, however, can utilize the ultra capacitor to harvest the spikes of the renewable power in that slot for future use.
   From the above, it can be concluded that a combined T1 and T2 can increase the renewable utilization. Similarly, it can be shown that a multi-tier management can decrease the cost incurred in using grid power.

The power provisioning of the servers (i.e., power state transition to active and inactive state) should be performed without compromising the performance requirements of the requests. Service delay is considered as the performance metric to assess this performance. To meet the performance requirements, the average delay of requests should not go above a reference delay, d^{ref}, where the value of the reference delay depends on the type of application. The average delay of servers can be modeled using standard queuing theory results. Without loss of generality, each data center is modeled as a M/M/n queuing model (if a data center happens to be modeled by other queuing models such as a G/G/n model, only the form of performance equations will vary yet the nature of the problem will remain the same). In a M/M/n queuing model, given that all workload requests are delayed at the queue, the average service delay is expressed as:

$$\frac{1}{μ} + \frac{1}{n μ - λ}$$

where μ denotes the service rate, and λ denotes the workload arrival rate to each data center. Other forms of delay such as the 99^{th} percentile of delay can be accounted for instead of the mean delay, which requires the approximation of the queue model or peak workload.

For the sake of simplicity, servers are assumed to have only two states: active and inactive. Further, it is assumed that the servers consume zero power in the inactive state and that each active server receives the same workload rate in steady-state. This is usually achieved through load balancing. Accordingly, the total power consumption of the data center can be obtained by multiplying the total number of active servers (denoted by y) and power consumption value for each server (denoted by p). To keep the optimization framework linear, p is set as the power consumption of servers when they are utilized at their peak utilization.

Energy storage is associated with several physical limitations. The cost of energy storage depends on the total energy that is to be stored/discharged, and its charging/discharging rate. The energy storage capacity is denoted as B^{size} measured in Joules. An ESD has limits on the maximum discharge and charge rate denoted by p^{max,discharge}, and p^{max,charge}, respectively. Typically, the charging rate is much less than the discharging rate (e.g., the charging rate is 5-10 times less than the discharging rate for lead-acid batteries). As discussed briefly above, the existing UPSes in data centers can be utilized for energy management of the tier one. However, the energy level of the battery should always be sufficient to guarantee the desired availability, denoted by Bₘᵢₙ. Further, the lifetime of an ESD depends on the type of the device, the way in which it is used, and several environmental factors such as temperature. Since a cost is incurred to replace the device, it is important to model its lifetime. The environmental factors are disregarded and the lifetime is simplified as follows.

An ESD is associated with a cycle-life (i.e., the number of charge/discharge cycles that can be accomplished during the lifetime of the device). Cycle-life is an estimate and depends upon an assumption of an average depth of discharge. The cost of a single duty cycling of an ESD is calculated by dividing its cost (capital cost) by the number of life cycles (the total number of life cycles is calculated considering depth of discharge that can be achieved for the constraint of Bₘᵢₙ and the maximum battery capacity B^{max}). For example, the cost of a charging or discharging of an energy storage that costs $500 and has 1000 life cycles is $0.5. This cost is denoted as Υ and incurred per charging/discharging cycle. The ESDs are associated with a self-discharge rate, denoted by η. To model energy storage, the energy storage level at time t is denoted by Bₜ with initial value B₀ and the charge/discharge at time t by p^{ESD}, where positive or negative values mean charge or discharge, respectively. The model and solutions herein account for two heterogeneous ESD in a data center. To distinguish between the two, the subscripts {1, 2} are used for ESD parameters, e.g., η₁, and η₂ denote the self-discharge of the level one and two ESD, respectively.

Wind and/or solar energy may be used as sources of renewable energy located on-site in a data center. Conventional models are used to generate solar power traces from irradiance and temperature and wind power traces from wind speed.

Electricity prices usually vary over time and location. The variation is due to several factors including power generation, and more importantly, supply-demand variation in the market. The supply-demand matching is important, as any mismatch between the two can induce a high cost. The reason is that power providers may need to add or remove the generation plants or load, both of which are costly. In order to minimize the high power draws by the consumers, electricity prices vary with the time of the day. Along with this, some utility providers also penalize the excess power draw by imposing an additional fee if the peak power draw exceeds the stipulated power in a certain time window e.g., 15 minutes. To this end, an electricity pricing model is used that accounts for both electricity cost per average energy consumption, αₜ, and β per excess peak power draw from stipulated power (denoted by p₀).

The objective of T1 is to manage energy buffering of the high energy density ESDs in a system, such as the first set of ESDs 16A, to leverage the long-term (epochs) variation of electricity pricing, workload and renewable in order to minimize the operational energy cost. To optimally decide on battery duty cycle, T1 should perform a cost optimization over a (possibly very long) time interval of interest T, as depicted in Equation (1) shown below in order to minimize electricity cost and energy storage cost.

$$minimize \\ [ power constraint ] , ∀ epoch t \text{:} \\ {\sum }_{t = 1}^{T} ( {p}_{t}^{AC} τ {α}_{t} + {b}_{1 , t} {γ}_{1} ) + {max}_{1 \leq t \leq T} {( {p}_{i , t}^{AC} - {p}_{0} )}^{+} {β}_{i} {r}_{t} + {p}_{t}^{AC} = {p}_{t}^{total} + {p}_{( 1 , t )}^{ESD} \\ [ battery equations ] , ∀ epoch t \text{:} \\ {B}_{1 , t + 1} = min ( {η}_{1} ( {B}_{1 , t} + {p}_{1 , t}^{ESD} τ ) , {B}_{1}^{max} ) \\ {B}_{1 , 0} = {B}_{min} \\ {B}_{1 , t} \geq {B}_{min} \\ [ battery cost constraint ] \text{:} \\ - {b}_{1 , t} {p}_{1}^{max , discharged} \leq {p}_{1 , t}^{ESD} \\ 0 \leq {b}_{i , t} \leq 1 \\ {r}_{t} \leq {r}_{t}^{total} \\ [ max . charging \text{/} discharging ] \text{:} \\ {p}_{1 , t}^{ESD} \leq {p}_{1}^{max , charge} \\ - {p}_{1 , t}^{ESD} \leq {p}_{1}^{max , discharge} \\ [ service constraint ] , ∀ epoch t \text{:} \\ {p}_{t}^{total} = {py}_{t} \\ {y}_{t} \leq N \\ [ queuing stability constraint ] , ∀ epoch t : \\ {y}_{t} {μ}_{t} > {λ}_{t} \\ [ performance constraint ] , ∀ epoch t : \\ {d}^{ref} \leq \frac{1}{μ} + \frac{1}{{y}_{t} μ - {λ}_{t}} \qquad ( 1 )$$

As shown above, the decision variables of T1 optimization cost framework are the average number of servers, yₜ, power draw from grid, pₜ^{AC}, renewable energy, rₜ, the energy level and power draw rate for the high energy density ESDs, B_{1,t}, and p_{1,t}^{ESD}. All of these variables are real, except for the number of servers, which are approximated as a real variable. The integer approximation of variable y provides a small approximation ration, and its effect in the objective function becomes negligible for a large number of servers. Note that except B_{1,t}, and p_{1,t}^{ESD}, all other decision variables are recalculated in T2. Three terms in the T1 objective are the cost for actual energy consumption, battery cost, and peak power cost due to exceeding from p₀, stipulated peak power. Note that the peak power is assumed to be calculated over T (time horizon of T1). Further, the renewable energy cost is set to zero to enable their maximum utilization. Furthermore, ESD life-cycle cost is formalized as γ₁b_{1,t}, where γ₁ denotes the life-cycle cost per maximum discharging rate, and b_{1,t} (0≦b_{1,t}≦1) is a variable to incur battery life-cycle cost proportion to the ratio of discharging rate. The T1 optimization is subject to the following constraints:
power constraints, which assert the power demand and supply balance;
battery constraints: (i) battery equations which assert the energy level of ESDs over time affected by its charging/discharging, p^{ESD}, and its self-discharge ratio, η, (ii) battery cost which specifies a set of equations to incur cost per discharging using a linear approximation equation, and (iii) maximum battery charging and discharging rate;
service constraints, which specify the total power demand and assert that the number of active servers should not exceed the total number of servers;
a queuing stability constraint, which asserts the M/M/n stability condition;
a performance constraint, which asserts the number of active servers, should be chosen such that service delay is less than the workload delay requirement, d^{ref}.

T2 accounts for short-term energy management. The optimization process is performed at small time intervals (e.g., minutes) called slots. The inputs are solutions to T1 (i.e. B_{1,t}, pₜₜ^{ESD}), as well as the transient profile of workload and renewable energy sources. Workload and renewable transient profile are assumed to be known over the entire epoch. T2 adjusts the power state of servers to the input workload and charging/discharging of the low energy density ESDs in the system, such as the second set of ESDs 16B. The term k is used to denote a slot index, and K to denote the total number of slots in an epoch. The optimization formulation in T2 is similar to that of tier one, except that it uses some of the inputs from T1, as shown in Equation (2) below.

$$minimize [ power constraint ] , ∀ slot k \text{:} {\sum }_{k = 1}^{K} ( {p}_{k , t}^{AC} {τ}^{′} {α}_{t} + {b}_{2 , k , t} {γ}_{2} ) + {max}_{1 \leq k \leq T} {( {p}_{k}^{AC} - {p}_{0} )}^{+} β {r}_{k , t} + {p}_{k , t}^{AC} = {p}_{k , t}^{total} + {p}_{1 , t}^{ESD} + {p}_{2 , k , t}^{ESD} \\ [ battery equations ] , ∀ slot k \text{:} \\ {B}_{2 , k + 1 , t} = min ( {η}_{2} ( {B}_{2 , k , t} + {p}_{2 , k , t}^{ESD} {τ}^{′} ) , {B}_{2}^{max} ) \\ [ battery cost ] \text{:} \\ - {b}_{2 , k , t} {p}_{2}^{max , charge} \leq {p}_{2 , k , t}^{ESD} \\ {r}_{k , t} \leq {r}_{k , t}^{total} \\ 0 \leq {b}_{i , k , t} \leq 1 \\ [ max . charging \text{/} discharging ] \text{:} \\ {p}_{2 , k , t}^{ESD} \leq {p}_{2}^{max , discharge} \\ - {p}_{2 , k , t}^{ESD} \leq {p}_{2}^{max , discharge} \\ [ service constraints ] \text{:} \\ {p}_{k , t}^{total} = {py}_{k , t} \\ {y}_{k , t} \leq N \\ [ queuing stability constraints ] \text{:} \\ {y}_{k , t} {μ}_{k , t} \geq {λ}_{k , t} \\ [ performance constraints ] \text{:} \\ {d}^{ref} \leq \frac{1}{μ} + \frac{1}{{y}_{t} μ - {λ}_{k , t}} \qquad ( 2 )$$

Equation (2) specifies how many active servers are required for each slot (i.e., y_{k,t}), and what portion of power is drawn from grid p_{k,t}^{AC}, renewable energy r_{k,t}, and the low energy density ESDs, p_{2,k,t}^{ESD}. Similar to T1, T2 cost objective accounts for electricity cost, the cost of the low energy density ESDs, and peak power cost. The peak power cost is included to force T2 to smooth the power consumption over every epoch. Similar to T1, T2 optimization is performed under constraints of energy storage, service, and performance (see above). Particularly, the power demand and supply balance of T2 considers the possible charging/discharging of the high energy density ESDs which is decided by T1.

As shown above, both T1 and T2 are developed as linear programming problems, where a linear program solver can optimally solve them. However, the optimal solution can only be achieved if all information (e.g., renewable power, workload, and electricity price) is known in advance. In reality, it is almost impossible to get said information for a large time interval (at least a month, since the peak power is usually calculated monthly). For that, the efficiency of the schemes is evaluated using a prediction technique for workload and renewable power and rolling horizon control (RHC) technique. For example, consider a window of length W≦T. RHC obtains T1 solutions at time t by solving the cost optimization of T1 over the window (t, t+W), given the T1 solution at time t−1.

In this solution method, T1 on every epoch predicts the long-term workload and renewable power variation, solves the optimization problem, Equation (1), to determine the duty cycling of the high energy density ESDs, and reports it to T2. On every slot, T2 predicts the short term workload and renewable power over the window of length K, solves the T2 cost optimization, Equation (2), to determine the number of active servers, and the duty cycling of the low energy density ESDs. Note that peak power is usually calculated over long time periods (e.g., a month). Neither T1, nor T2, can smooth the peak power over a month (the prediction window of T1 is much less than a month), but they smooth the peak power over their respective windows, which indirectly helps to smooth the peak power over a month.

In light of the above, an analytical basis for the benefits of a multi-tier energy management scheme can be shown under practical assumptions on the availability of the wind energy and data center power consumption. Consider a data center that utilizes on-site wind power and grid to power its servers. Further assume the grid power is offered with fixed price over time (i.e., αₜ=α, ∀t, and β=0). Furthermore, assume that the high energy density ESDs have unlimited capacity (i.e., β₁^{max}≃∞), is associated with an infinite number of life-cycles (i.e., γ₁≃0), and has no self-discharge (i.e., η=1). Let p̅ₜ denote the expected power demand, and r̅ₜ denote the expected available renewable power over epoch t. T1 decides on charging and discharging of the high energy density ESDs based on p̅ₜ and r̅ₜ values to maximally utilize renewable. However, the available renewable power varies within epochs. Particularly, it has been shown that wind generation can be modeled as a non-stationary Gaussian random process within epochs (i.e., the renewable power generation amount in the kth slot of epoch t is given by: r_{k,t}˜ [symbol] ( r̅ₜ,sᵣ²), where r̅ₜ is the mean and sᵣ² is the variance). Power demand depends on the input workload as well as servers' idle and peak power. To quantify the variation of power demand within epochs, two cases are considered: (i) power demand is almost constant within epochs, which is true when the number of active servers does not change within epochs and servers' idle power is very large i.e., p_{k,t}= p̅, ∀k=1 . . . K, and (ii) power demand varies as a Gaussian stochastic process during epochs (note that Web workload follows a heavy tail stochastic process, the resulting power consumption of the workload, however, may or may not follow such a heavy-tail stochastic process, i.e. p_{k,t}˜ [symbol] ( p̅ₜ,sₚ²)). The two following lemma and corollary illustrate how combined T1 and T2 potentially increase the renewable utilization compared to T1 only. The lemmata are given for optimal T1 where (i) the input data for the entire time horizon T is given, (ii) T1 is assumed to be optimally solved, and (iii) T is very large, e.g., a year.

Lemma 1: Given Gaussian distribution for the variation of the renewable power within epochs with mean r̅ₜ and variance sᵣ², and a constant power demand of p̅ₜ, the optimal T1, single-tier energy buffering management for epochs of length τ, utilizing battery with characteristics of B^{max}=∞, η_{avg}=1, γ=0 and p^{max,charge}, on average at least wastes wₜ^{avg} of the available renewable energy during epoch t, where

$${w}_{t}^{avg} = min ( τ [ \frac{{s}_{r}}{\sqrt{2 π}} {e}^{\frac{- {( {\overline{p}}_{t} - {\overline{r}}_{t} )}^{2}}{2 {s}_{r}^{2}}} + \frac{{\overline{r}}_{t}}{2} ( 1 - erf ( {\overline{p}}_{t} - {\overline{r}}_{t} ) ) ] , τ [ \frac{{s}_{r}}{\sqrt{2 π}} {e}^{\frac{- {( {\overline{p}}_{t} + {p}^{max , charge} - {\overline{r}}_{t} )}^{2}}{2 {s}_{r}^{2}}} + \frac{{\overline{r}}_{t}}{2} ( 1 - erf ( {\overline{p}}_{t} + {p}^{max , charge} - {\overline{r}}_{t} ) ) ] .$$

Due to the given assumptions (i.e., constant electricity cost, zero battery charging/discharging cycle cost and infinite battery capacity, and that T1 is expected to run for a very large T (i.e., T→∞), where there is always power demand and lack of renewable power over time), it is shown that T1 stores all of the excess renewable energy over every epoch. Two cases are then considered.

Case One: assuming r̅ₜ≦ p̅ₜ, then there is no excess renewable energy (on average) to be stored at tier one battery. T1 (optimal) decides on not charging the battery from the available renewable energy. A random variable is defined to denote the difference between the available renewable energy and the power demand for every slot within epochs as follows: r_{t,k}^{diff}=(r_{t,k}−p_{t,k}). Then, given a T1 battery management, the expected available renewable energy wastage for a slot is equal to [symbol] (r_{t,k}^{diff}>0):

$${w}_{k , t}^{avg , case 1} = ( {r}_{t , k}^{diff} \geq 0 ) = ( {r}_{t , k} \geq {\overline{p}}_{t} ) = {\int }_{\overline{p}}^{+ ∞} \frac{1}{{s}_{r} \sqrt{2 π}} {e}^{- \frac{{( x - \overline{r} )}^{2}}{2 {s}_{r}^{2}}} x d x = \frac{{s}_{r}}{\sqrt{2 π}} {e}^{\frac{- {( {\overline{p}}_{t} - {\overline{r}}_{t} )}^{2}}{2 {s}_{r}^{2}}} + \frac{{\overline{r}}_{t}}{2} ( 1 - erf ( {\overline{p}}_{t} - {\overline{r}}_{t} ) ) .$$

Considering that there are K slots of length τ′ in an epoch where Kτ′=τ, and that the expected value of sum of independent random variables equals to the sum of the expected values for each variable, we have that wₜ^{avg,case1}=τw_{k,t}^{avg,case1}.

Case Two: assuming r̅ₜ> p̅ₜ, then T1 decides on charging of the battery. However, due to limitation on the maximum charging rate of the battery, the renewable energy will be wasted if r_{k,t}>p^{max,charge}+ p̅ₜ. Thus the expected renewable energy wastage for every slot equals:

$${w}_{k , t}^{avg , case 2} = ( {r}_{t , k}^{diff} > {p}^{max , charge} = {r}_{t , k} \geq {\overline{p}}_{t} + {p}^{max , charge} ) = {\int }_{\overline{p} + {p}^{max , charge}}^{+ ∞} \frac{1}{{s}_{r} \sqrt{2 π}} {e}^{- \frac{{( x - \overline{r} )}^{2}}{2 {s}_{r}^{2}}} x d x = τ [ \frac{{s}_{r}}{\sqrt{2 π}} {e}^{\frac{- {( {\overline{p}}_{t} + {p}^{max , charge} - {\overline{r}}_{t} )}^{2}}{2 {s}_{r}^{2}}} ] . \qquad ( 4 )$$

Considering that wₜ^{avg}=min(wₜ^{avg,case1},wₜ^{avg,case2}), the lemma follows. To quantify the result of the above lemma suppose r̅ₜ= p̅ₜ, then the expected renewable energy wastage for epoch t, using only T1 battery management becomes

$${w}_{t}^{avg} = τ ( \frac{{s}_{r}}{\sqrt{2 π}} + \frac{\overline{r}}{2} ) ,$$

which means that at least half of the available energy during epoch t is wasted.

Corollary 1: Given Gaussian distribution for the variation of both the available renewable power and the power demand within epochs with mean r̅ₜ, p̅ₜ, and variance sᵣ² and sₚ², then T1, single-tier energy buffering management for epochs of length τ, utilizing battery with characteristics of B^{max}≃∞, η=1, γ=0 and p^{max,charge}, on average wastes wₜ^{avg} of the available renewable energy during epoch t, where

$${w}_{t}^{avg} = min ( τ [ \sqrt{\frac{{s}_{r}^{2} + {s}_{p}^{2}}{2 π}} {e}^{\frac{- {( {\overline{p}}_{t} - {\overline{r}}_{t} )}^{2}}{2 ( {s}_{r}^{2} + {s}_{p}^{2} )}} + \frac{{\overline{r}}_{t} - {\overline{p}}_{t}}{2} ( 1 - erf ( {\overline{p}}_{t} - {\overline{r}}_{t} ) ) ] , τ [ \sqrt{\frac{{s}_{r}^{2} + {s}_{p}^{2}}{2 π}} {e}^{\frac{- {( {p}^{max , charge} - ( {\overline{r}}_{t} - {\overline{p}}_{t} ) )}^{2}}{2 ( {s}_{r}^{2} + {s}_{p}^{2} )}} + \frac{{\overline{r}}_{t} - {\overline{p}}_{t}}{2} ( 1 - erf ( {p}^{max , charge} - ( {\overline{r}}_{t} ) - ( {\overline{p}}_{t} ) ) ) ] .$$

The above corollary follows from Lemma 1, given that the difference of two Gaussian random variables with mean μ₁ and μ₂, and the variance σ₁² and σ₂² is a Gaussian variable with mean μ₁−μ₂ and variance σ₁²−σ₂². Consequently, r_{t,k}^{diff}˜ [symbol] ( r̅ₜ− p̅ₜ, \sqrt{sₚ²+sᵣ²}).

To quantify the result of Corollary 1 suppose r̅ₜ= p̅ₜ, then the renewable energy wastage due to only T1 battery management becomes

$${w}_{t}^{avg} = τ \sqrt{\frac{{s}_{r}^{2} + {s}_{p}^{2}}{2 π}} .$$

The above analysis is performed for wind energy and the assumption that the electricity price is constant within epochs. In reality, on-site renewable energy in data centers is dominated by both wind and solar energy, where solar energy also exhibits short-term variation, as discussed in further detail below. Further, electricity price may vary in intervals of less than epochs (e.g., 15 minutes), which further motivates the multi-tier energy management scheme described herein. The above analytical results suggest that depending on the variability of the available renewable and power demand within epochs, a single-tier energy buffering management (i.e., T1 only) cannot optimally harvest the renewable power. A combined T1 and T2 solution, however, can explore the variation of the power demand and supply over and within epochs, resulting in less renewable energy wastage.

In a simulation, a data center with 500 homogeneous servers where each server consumes 400 W at its peak and can handle up to 200 request per second is assumed to have Lead Acid (LA) batteries and Ultra Capacitors (UC), accessible in a centralized manner (all servers have access to both types of ESDs) and with characteristics shown in Table II, shown below:

| Parameters | LA | UC |
|---|---|---|
| Cost per discharge | 0.25 | 0.0115 |
| Cycle life of one cell | 1.2 | 1000 |
| (×10³ cycles) | | |
| Discharge rate (KW) | 5.4 | 42.5 |
| Discharge-to-charge ratio | 10 | 1 |
| Depth-of-discharge (%) | 80 | 100 |
| Self discharge per day (%) | 0.1 | 20 |

Further, the simulation uses one month traces of renewable power and workload, as described in further detail below, and the average electricity prices of California for average power draw from the grid (i.e., α), which varies every 30 minutes. Further, it is assumed that p₀=60 kW, a value that is 60% more than average power consumption of the simulated data center. An excess charge of $12/kW for the peak power draw (i.e., β) of every hour within a window of one month. Also, the prediction window of T1 (i.e., W) is set to 24 hours.

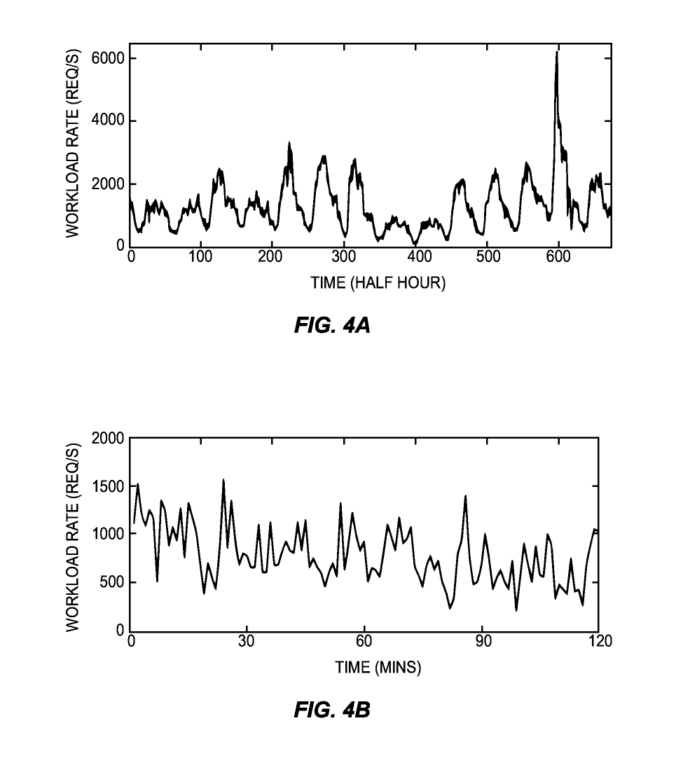

A simulated workload is generated with a sampled request rate (req/s) of every 1 minute and 30 seconds. One exemplary workload is shown in FIGS. 4A and 4B, which demonstrate the hourly variability of the workload and the minute-by-minute variation of the workload, respectively. This workload is scaled to the capacity of the simulated data center. The workload intensity is such that on average around 100 active servers are required. The workload for the two tiers of management is predicted. The workload exhibits daily and weekly seasonality due to the usage patterns of clients that show more activity during the peak hours of the day. Hence, the workload with time interval for T1 can be consistently predicted using a seasonal prediction model with seasonality introduced based on the data of the previous day at the same time as well as the change in the workload in few previous epochs. For example, the initial realistic trace history is taken as the July workload trace, which is then used to predict data for the month of August. In T2, however, there are fine variations in the workload that cannot be captured in a seasonal model. Accordingly, a moving average prediction technique is used. The prediction data of T1 for the epoch length of 30 minutes shows a prediction error of 19.6% for forecast window of 1 and increases with the size of the forecast window up to 40.2%. For T2, with a forecast window of 1, the error is 27.2% and increases up to 48% with an increase in the size of the forecast window. For epochs of length 1 hour a prediction error of 21.8% increases up to 29.67% for a 24 hour forecast window.

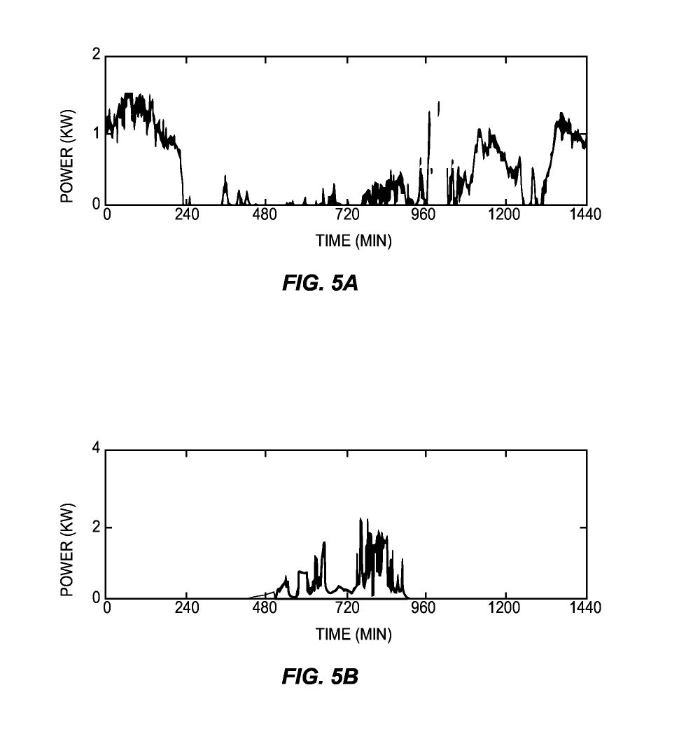

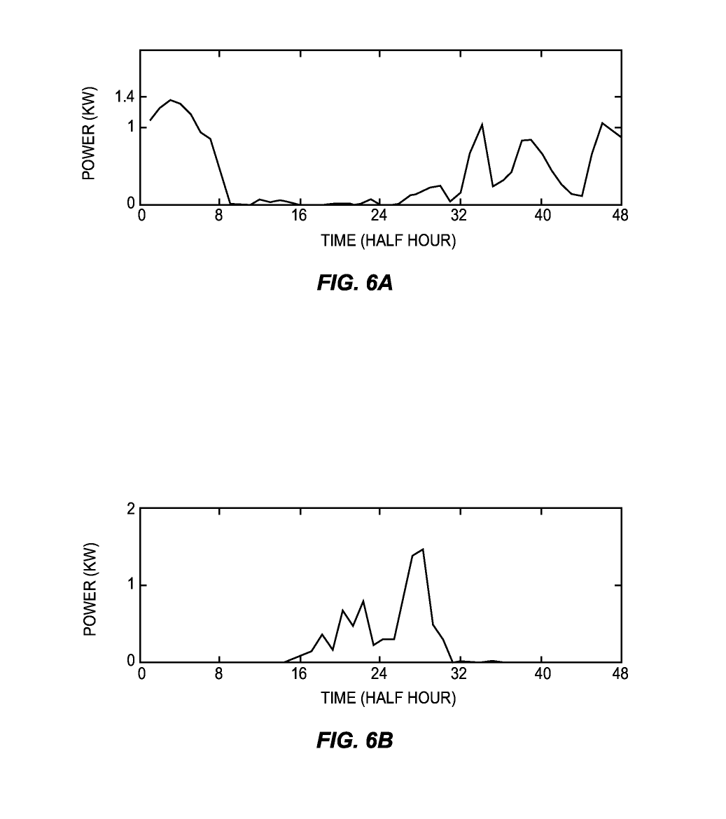

To capture the availability of wind and solar energy, any number of simulated or non-simulated traces may be used. Two exemplary traces are shown in FIGS. 5A and 5B, which show an exemplary variation of wind power per minute and variation of solar power per minute, respectively. Wind speed and the rated power are used to calculate the wind power, and global horizontal irradiance (GHI) and the ambient temperature are used to calculate the solar power. The traces are for intervals of one minute and a duration of two months (e.g., July and August). FIGS. 5A and 5B demonstrate the intermittent availability of the wind and solar power sources over minutes. These observations agree with the assumptions discussed above about short-term variation of both wind and solar power. Similarly, FIGS. 6A and 6B show every half-hour variation of wind and solar power during one day.

The number of solar cells and wind turbines are varied so at the maximum rated power output of each, two renewable power rates supply 10% and 60% of peak power draw of the data center. The daily pattern is observed for the solar energy with maximum energy observed in the afternoon. This pattern is characterized using a seasonal auto regressive integrated moving average (ARIMA) technique to predict solar power for a day ahead to be used in T1. The variation in the wind energy is not seasonal; hence, exponential smoothening and moving averages are used in order to predict it. Using seasonal ARIMA, the solar power for a half hour epoch (T1) and a forecast window of one epoch shows prediction error of 17.56%, which increases to 21.65% for the prediction window of a day (48 epochs). Similarly, the wind power prediction for a half hour epoch and a forecast window of 1 shows error of 27.41% and increases to 34.76% for the prediction window of a day (48 epochs). A moving average technique is used to predict solar and wind power over an epoch to be used by T2. The prediction error in this case is higher than prediction error for T1.

Experiments performed to evaluate the efficiency of T1 and T2 versus different capacities of ESDs, prediction error, electricity pricing models, epoch length and the available renewable power also show an advantage to the multi-tier approach described herein. In these experiments, ESD capacity values are chosen that are comparable to the energy requirement of the simulated data center when working at its peak for a specific duration (e.g., ESD of size 1.2 MJ is enough for the data center to work for one second at its peak). In the experiments, combined T1 and T2 are performed when ESD capacity of both levels have non-zero values. Whereas, single-tier energy buffering management, T1, is performed when the high energy density ESDs have non-zero capacity value, and the low energy density ESDs have zero capacity value. Finally, zero capacity of ESDs at both levels means that energy buffering management is not performed at any of the tiers. Note that for the fair comparison of T1 and T2's cost saving, workload management is always performed in slots. In other words, the reported values of cost and power for all of the figures are the solutions of Equation (2), with the specified ESD capacity at each level.

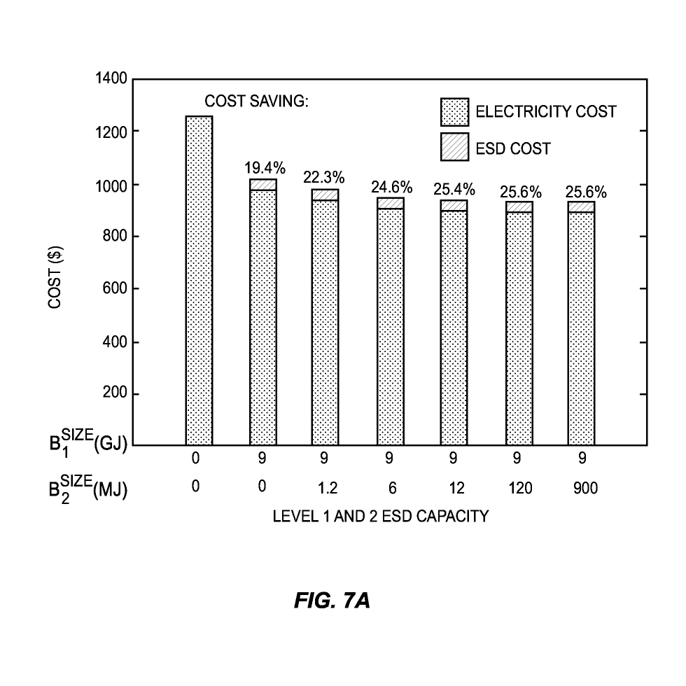

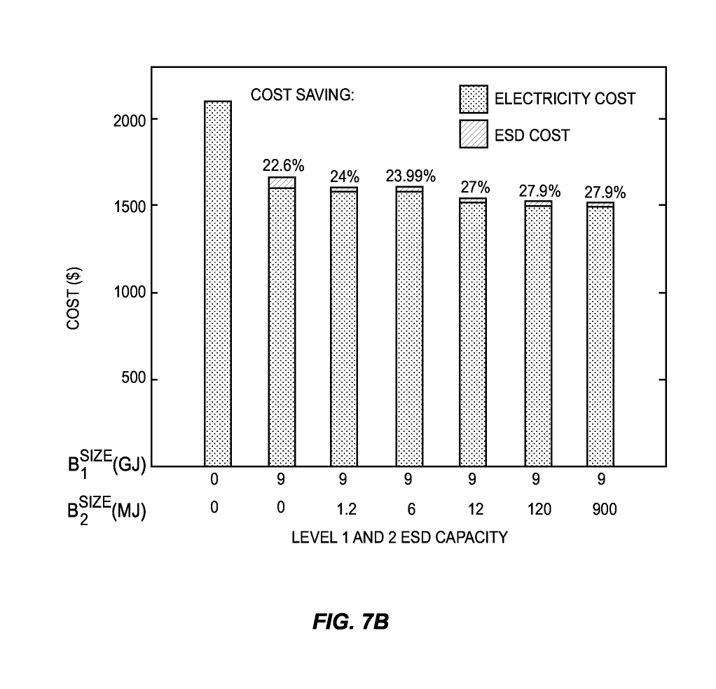

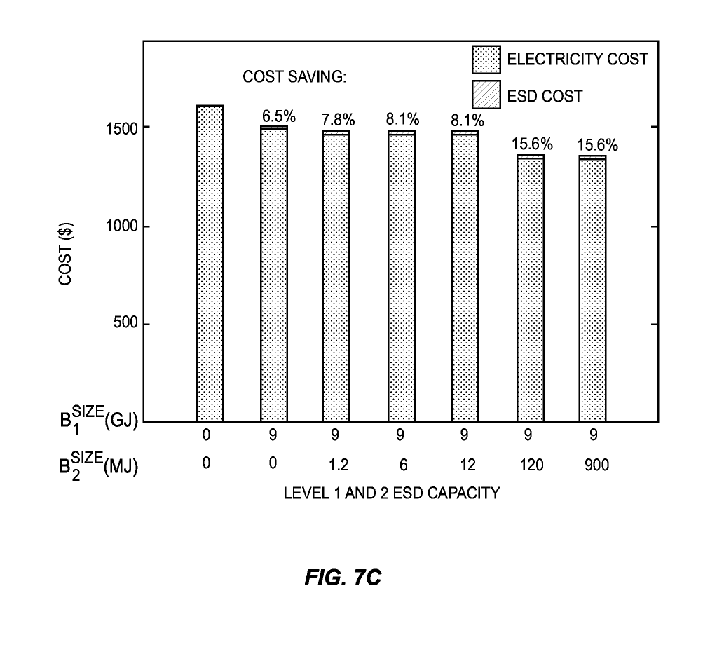

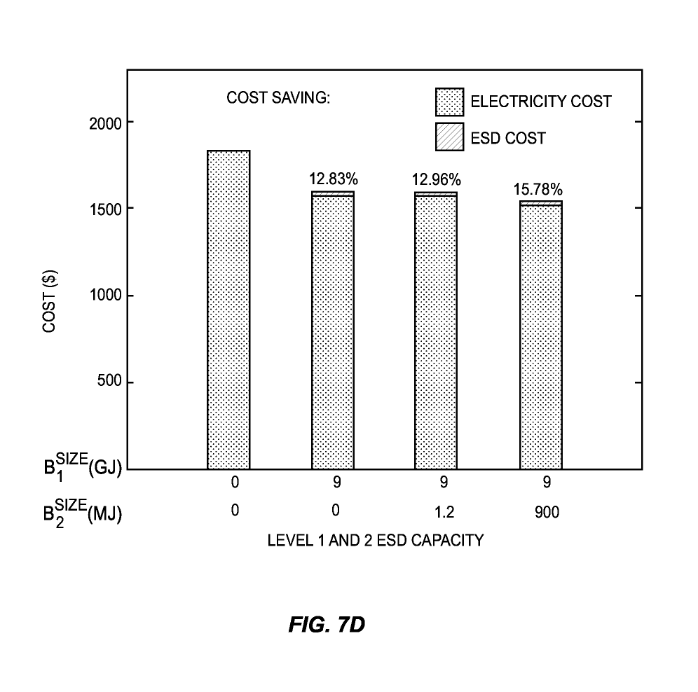

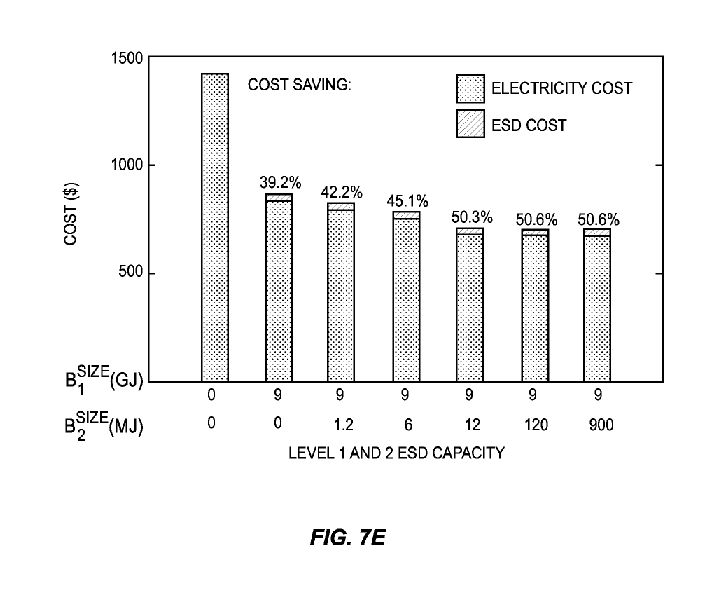

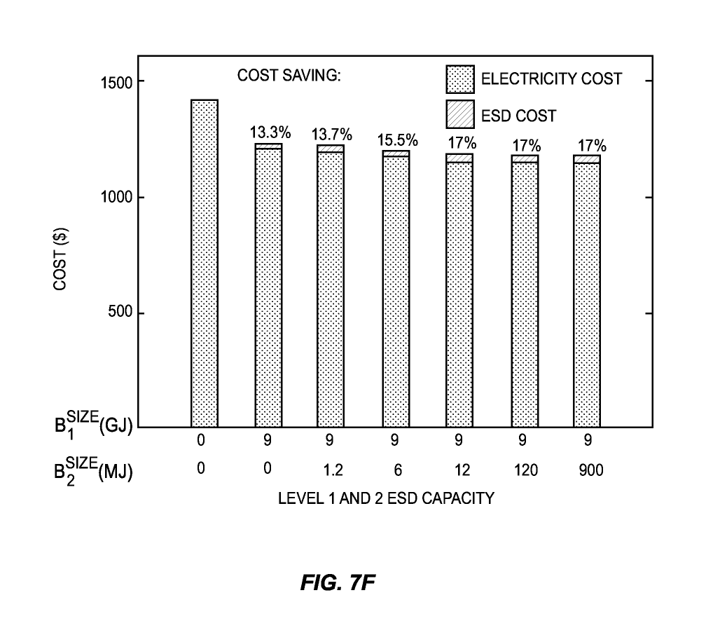

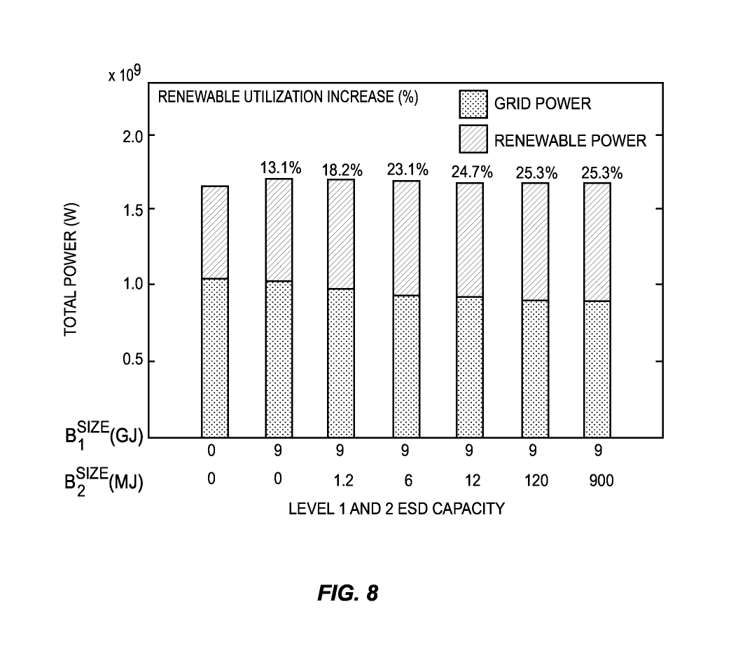

The experiments described below are performed when renewable sources contribute only 10% of the data center total power. Due to such low renewable power, the cost saving difference of combined T1 and T2 mainly comes from leveraging the electricity price variation within epochs. In order to investigate the maximum cost saving of the two-tier management scheme, the simulation is run when T1 and T2 access the actual data of workload and renewable over their decision window (24 hours for T1, and 30/60 minutes for T2 depending on the epoch length). The simulation is also run for two electricity pricing models (i) β=0, no cost per peak power draw, and (ii) β=$12 kW, and various capacities of ESDs. Since the costs savings of two-tier energy buffering management compared to one-tier management is of primary concern, the capacity of the high energy density ESDs is set to a very large value, (9 GJ, enough energy for an hour work of data center at its peak utilization). This value is chosen to ensure that the cost saving of T2 is due to variation in demand and supply and not due to low capacity of the high energy density ESDs. FIG. 7A shows that the maximum cost saving of one-tier management for zero value of β is 19% that increases to 25% using combined T1 and T2. The cost saving of combined T1 and T2 is higher for non-zero β, as shown in FIG. 7B, since ESDs are utilized to decrease the peak power draw from grid. It can be seen in both figures that the cost of ESDs does not increase with increase in the size of the level two ESD. The reason is that the high energy density ESDs are the major contributor of the cost, since the low energy density ESDs have a very large number of cycles.

As shown in FIG. 7C, the cost savings of both T1 and T2 are reduced for an epoch length of one hour (compare FIG. 7B and FIG. 7C). The reason is that T1 cannot leverage electricity variation in the intervals of half an hour since it is not aware of that information. T2 can compensate the performance of T1 and incur a high cost saving by deploying relatively large ESD (i.e., 120 MJ, enough energy for 12 minutes work of data center at its peak utilization). T2 needs large ESDs to be able to store energy within an hour.

As shown in FIG. 7D, when T1 and T2 decide based on prediction data, their cost saving decreases due to prediction error (compare FIG. 7B and FIG. 7D). However, still the combination of T1 and T2 incur up to 4% more cost saving compared to using T1 only. Any prediction technique with higher accuracy can be used to improve the cost saving of T1 and T2.

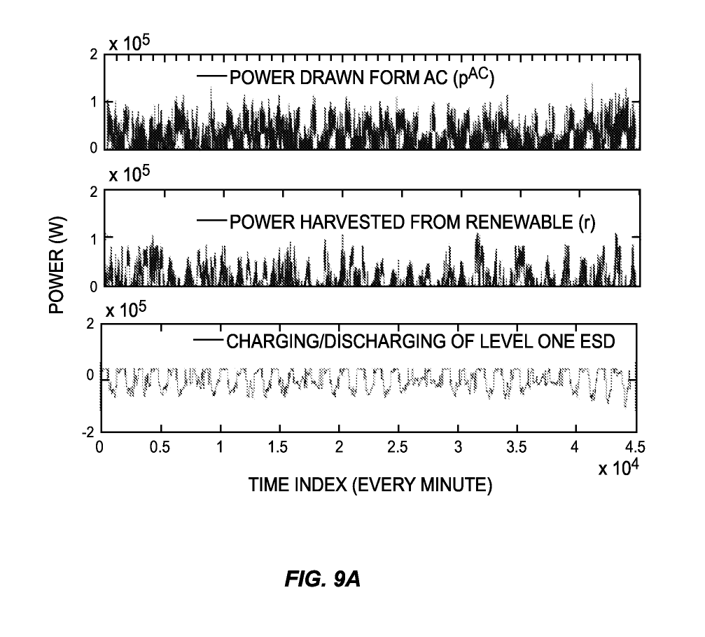

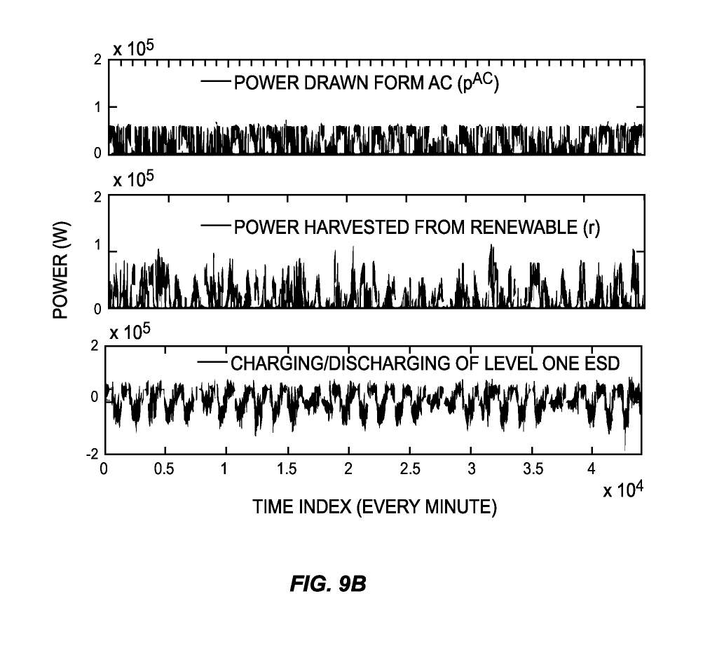

In all of the previous experiments, renewable power contributes less than 10% of the data center total required power, where renewable utilization is almost equal with and without energy buffering management (i.e., T1 and T2). To demonstrate the efficiency of T1 and T2 in utilizing renewable energy sources, the renewable power generation parameters are set such that the renewable power sources contribute around 60% of the data center total power at its peak. FIG. 7E shows that in this case energy cost decreases by 39% when using T1 with perfect prediction (zero prediction error). The cost saving increases up to 50% when using combined T1 and T2. Note that on-site renewable energy sources are assumed with zero operational cost. In other words, the extra cost saving of FIG. 7E compared to FIG. 7C comes from increasing renewable energy utilization. This has been shown in FIG. 8 and FIG. 9. FIG. 8 shows the extra renewable energy that a combined T1 and T2 can harvest compared to T1. FIG. 9 shows the power draw model of T1 (FIG. 9A) and the combined T1 and T2 (FIG. 9B), where the capacity of the high energy density ESDs at T1 for the both cases is set to 9 GJ, and the capacity of the low energy density ESDs for the case of combined T1 and T2 is 900 MJ. This figure shows that the extra renewable utilization and cost savings of combined T1 and T2 comes from close matching of renewable energy to the power demand and from smoothing power drawn from AC at short term using frequent charging and discharging of the low energy density ESDs (ultra capacitors).

FIG. 7F shows that T1 and T2, even when using predicted data, still increase the renewable utilization and save cost (compare FIG. 7F and FIG. 7D), albeit not as much as the case where data is accurately available to them (compare FIG. 7F and FIG. 7E).

Those skilled in the art will recognize improvements and modifications to the embodiments of the present disclosure. All such improvements and modifications are considered within the scope of the concepts disclosed herein and the claims that follow.

What is claimed is:

1. An energy management control system comprising:
a memory and processor configured to evaluate short and long term variation of a plurality of energy delivery system characteristics of an energy delivery system, the energy delivery system including a plurality of power sources, a first plurality of energy storage devices (ESDs) having a first set of operating characteristics including a first energy storage efficiency, a first discharge rate, and a first energy storage capacity, and a second plurality of ESDs having a second set of operating characteristics that are different from the first set of operating characteristics including a second energy storage efficiency, a second discharge rate, and a second energy storage capacity, wherein the plurality of energy delivery system characteristics include a power demand to a load and a price of electricity from each one of the plurality of power sources; and
communications circuitry configured to provide control signals to the energy delivery system in order to facilitate a selective delivery of power from the plurality of power sources to the first plurality of ESDs, the second plurality of ESDs, or both based on the short and long term variation of the plurality of energy delivery system characteristics.

2. The energy management control system of claim 1 wherein the plurality of energy delivery system characteristics further include the first set of operating characteristics and the second set of operating characteristics.

3. The energy management control system of claim 2 wherein the communications circuitry is further configured to provide control signals to the energy delivery system in order to facilitate the selective delivery of power between the first plurality of ESDs and the second plurality of ESDs based on the plurality of energy delivery system characteristics.

4. The energy management control system of claim 1 wherein the communications circuitry is further configured to provide control signals to the energy delivery system in order to facilitate the selective delivery of power between the first plurality of ESDs and the second plurality of ESDs based on the plurality of energy delivery system characteristics.

5. The energy management control system of claim 1 wherein the plurality of power sources comprise a renewable energy source and a power grid.

6. The energy management control system of claim 5 wherein the renewable energy source is one of a solar energy source and a wind energy source.

7. The energy management control system of claim 1 wherein the first plurality of ESDs are batteries and the second plurality of ESDs are ultra-capacitors.

8. The energy management control system of claim 1 wherein a short term variability of power demand to the load is a variability of power demand to the load over a period of minutes and a long term variability of power demand to the load is a variability of power demand to the load over a period of hours.

9. The energy management control system of claim 1 wherein the load is an internet data center (IDC).

10. The energy management control system of claim 9 wherein the plurality of energy delivery system characteristics further include a number of active servers in the computer data center.

11. The energy management control system of claim 10 wherein the plurality of energy delivery system characteristics further include the first set of operating characteristics and the second set of operating characteristics.

12. A method of operating an energy management control system for an energy management system comprising:
providing control signals to facilitate a selective delivery of power from a plurality of power sources to a first plurality of energy storage devices (ESDs), a second plurality of ESDs, or both based on a short term and long term variation of a plurality of energy delivery system characteristics including power demand to a load and a price of electricity from each one of the plurality of power sources, wherein the first plurality of ESDs have a first set of operating characteristics including a first energy storage efficiency, a first discharge rate, and a first energy storage capacity and the second set of ESDs have a second set of operating characteristics that are different from the first set of operating characteristics and include a second energy storage efficiency, a second discharge rate, and a second energy storage capacity; and
providing control signals to facilitate the selective delivery of power from the first plurality of ESDs, the second plurality of ESDs, or both to the load based on the plurality of energy delivery system characteristics.

13. The method of claim 12 wherein the plurality of energy delivery system characteristics further include the first set of operating characteristics and the second set of operating characteristics.

14. The method of claim 13 further comprising providing control signals to facilitate the selective delivery of power between the first plurality of ESDs and the second plurality of ESDs based on the plurality of energy delivery system characteristics.

15. The method of claim 12 further comprising providing control signals to facilitate the selective delivery of power between the first plurality of ESDs and the second plurality of ESDs based on the plurality of energy delivery system characteristics.

16. The method of claim 12 wherein the plurality of power sources comprise a renewable energy source and a power grid.

17. The method of claim 16 wherein the renewable energy source is one of a solar energy source and a wind energy source.

18. The method of claim 12 wherein the first plurality of ESDs are batteries and the second plurality of ESDs are ultra-capacitors.

19. The method of claim 12 wherein a short term variability of power demand to the load is a variability of power demand to the load over a period of minutes and a long term variability of power demand to the load is a variability of power demand to the load over a period of hours.

20. The method of claim 12 wherein the load is an internet data center (IDC).

21. The method of claim 20 wherein the plurality of energy delivery system characteristics further include a number of active servers in the computer data center.

22. The method of claim 21 wherein the plurality of energy delivery system characteristics further include the first set of operating characteristics and the second set of operating characteristics.

23. An energy management system comprising:
a plurality of power sources;
a load;
a first plurality of energy storage devices (ESDs) coupled between the plurality of power sources and the load and having a first set of operating characteristics including a first energy storage efficiency, a first discharge rate, and a first energy storage capacity;
a second plurality of ESDs coupled between the plurality of power sources and the load and having a second set of operating characteristics that are different from the first set of operating characteristics and include a second energy storage efficiency, a second discharge rate, and a second energy storage capacity; and
an energy management control system configured to:
selectively deliver power from one or more of the plurality of power sources to the first plurality of ESDs, the second plurality of ESDs, or both based on a short term and long term variation of a plurality of energy delivery system characteristics including a power demand to the load and a price of electricity from each one of the plurality of power sources; and
selectively deliver power from the first plurality of ESDs, the second plurality of ESDs, or both to the load based on the plurality of energy delivery system characteristics.
